(19) United States
(12) Patent Application Publication
(10) Pub. No.: US 2020/0404555 A1
(43) Pub. Date: Dec. 24, 2020

(54) Altitude Dependent Neighbour Relations in a Wireless Communication Network

(71) Applicant: Telefonaktiebolaget LM Ericsson (publ), Stockholm (SE)

(72) Inventors: Peter Ökvist, Luleå (SE); Tommy Arngren, Södra Sunderby (SE); Stefan Wänstedt, Luleå (SE)

(21) Appl. No.: 16/629,374

(22) PCT Filed: Jul. 12, 2017
(86) PCT No.: PCT/EP2017/067592

§ 371 Date: Jan. 8, 2020

(51) Int. Cl. H04W 36/00; H04W 48/08; H04W 24/02

(52) U.S. Cl. CPC H04W 36/0083; H04W 24/02; H04W 48/08; H04W 36/0061

(57) ABSTRACT

In a wireless communication network, a device for handling neighbour relations of a first cell selects, based on the altitude of a wireless device being served by the first cell, a set of neighbour relations (66) for the first cell from a number of sets (64, 66, 68) of neighbour relations, where each set is associated with a different altitude interval (AI1, AI2, AI3), and determines neighbour cells for the wireless device based on the selected set of neighbour relations (66). The wireless device may in turn obtain a number of sets of neighbour relations (64, 66, 68) for the first cell, select, based on the altitude of the wireless device, a set of neighbour relations (66) for the first cell from a number of sets (64, 66, 68) of neighbour relations, and determine neighbour cells for the wireless device based on the selected set of neighbour relations (66).

### TECHNICAL FIELD

The invention relates to neighbour relations between cells in a wireless communication network. More particularly, the invention relates to a device, method, computer program and computer program product for handling neighbour relations of a first cell in a wireless communication network as well as to wireless device for communication with a first cell and to a method, computer program and computer program product for assisting in the handling of neighbour relations of a first cell in a wireless communication network.

### BACKGROUND

One function that exists in mobile communication networks is the Automatic Neighbour Relations (ANR) function. This function specifies neighbours of a serving cell as well as rules for how interactions are to be carried out between the serving and neighbour cells. The neighbour relations are often provided in a list or Neighbour Relations table (NRT), which may be updated based on measurement reports made by wireless devices such as User Equipment (UEs).

The purpose of the Automatic Neighbour Relation (ANR) function is to relieve the operator of the mobile communication network from the burden of manually managing Neighbour Relations (NRs). The ANR function typical resides in a base station, which in a Long Term Evolution (LTE) system is termed enhanced NodeB (eNB) or eNodeB, and manages the conceptual NRT which thus sets out the above mentioned rules.

Located within ANR, a Neighbour Detection Function finds new neighbours and adds them to the NRT. ANR also contains a Neighbour Removal Function which removes outdated NRs.

The neighbour relations functionality is fairly static but functions well in most cases.

However, recently unmanned aerial vessels, such as drones, have emerged requiring wireless communication capabilities. Apart from moving relatively fast such devices may travel at different heights or altitudes.

Moreover, it is then possible that for a wireless device the radio environment may differ due to the altitude. Shadow fading characteristics such as blocking or partial blocking from buildings and ground level topology and foliage may thus vary considerably with altitude, especially in an urban environment.

For this and other reasons it may therefore be of interest to improve on the neighbour relations function for a cell serving a wireless device through making the neighbour relations function more flexible.

### SUMMARY

One object of some embodiments is to provide more flexible neighbour relations of a cell serving a wireless device.

This object is according to a first embodiment of the invention achieved through a device for handling neighbour relations of a first cell in a wireless communication network. The device comprises processing circuitry that, for a wireless device that is served by the first cell, is configured to:

select, based on the altitude of the wireless device, a set of neighbour relations for the first cell from a number of sets of neighbour relations; and
determine neighbour cells for the wireless device based on the selected set of neighbour relations.

Moreover, each set of neighbour relations that may be selected is associated with a different altitude interval.

According to a first variation of the first embodiment, the processing circuitry is further configured to obtain an indication of the altitude of the wireless device and perform the selection based on the indication.

According to a second variation of the first embodiment, the processing circuitry is further configured to inform the wireless device of the selected set of neighbour relations

According to a third variation of the first embodiment, the processing circuitry, when informing the wireless device of the selection, is also configured to inform the wireless device of the content of the selected set of neighbour relations.

According to a fourth variation of the first embodiment, the processing circuitry is further configured to inform the wireless device of the content of all the sets of neighbour relations.

According to a fifth variation of the first embodiment, the processing circuitry is further configured to initiate a handover of the wireless device from the first cell to one of the determined neighbour cells.

The device for handling neighbour relations may with advantage be a radio base station.

The above-mentioned object is according to a second embodiment of the invention achieved through a method of handling neighbour relations of a first cell in a wireless communication network. The method is performed by a device for handling neighbour relations and in relation to a wireless device that is served by the first cell. The method comprises: selecting, based on the altitude of the wireless device, a set of neighbour relations for the first cell from a number of sets of neighbour relations; and determining neighbour cells for the wireless device based on the selected set of neighbour relations.

Each set of neighbour relations that may be selected is furthermore associated with a different altitude interval.

According to a first variation of the second embodiment, the method further comprises obtaining an indication of the altitude of the wireless device and performing the selection based on the indication.

According to a second variation of the second embodiment, the method further comprises informing the wireless device of the selected set of neighbour relations.

According to a third variation of the second embodiment, the method further comprises informing the wireless device of the content of the selected set of neighbour relations when informing the wireless device of the selection.

According to a fourth variation of the second embodiment, the method comprises informing the wireless device of the content of all the sets of neighbour relations.

According to a fifth variation of the second embodiment, the method further comprises initiating a handover of the wireless device from the first cell to one of the determined neighbour cells.

The object of providing more flexible neighbour relations of a cell serving a wireless device is according to a third embodiment of the invention achieved through a computer program for handling neighbour relations of a first cell in a wireless communication network. The computer program comprises computer program code which when run in a device for handling neighbour relations, causes the device to:

select, based on the altitude of a wireless device being served by the first cell, a set of neighbour relations for the first cell from a number of sets of neighbour relations; and
determine neighbour cells for the wireless device based on the selected set of neighbour relations.

Each set of neighbour relations that may be selected is furthermore associated with a different altitude interval.

The object is according to a fourth embodiment achieved through a computer program product for handling neighbour relations of a first cell in a wireless communication network, where the computer program product comprises a data carrier with computer program code according to the third embodiment.

The above mentioned object of providing more flexible neighbour relations of a cell serving a wireless device is according to a fifth embodiment of the invention also achieved through a wireless device for communication with a first cell of a wireless communication network. The wireless device comprises processing circuitry configured to:

obtain a number of sets of neighbour relations for the first cell; select, based on the altitude of the wireless device, a set of neighbour relations for the first cell from a number of sets of neighbour relations; and determine neighbour cells for the wireless device, when the wireless device is being served by the first cell, based on the selected set of neighbour relations.

Each set of neighbour relations that may be selected is also associated with a different altitude interval.

According to a first variation of the fifth embodiment, the processing circuitry is further configured to perform cell reselection based on the determined neighbour cells.

According to a second variation of the fifth embodiment, the processing circuitry is further configured to make link quality determinations based on the determined neighbour cells.

According to a third variation of the fifth embodiment, the processing circuitry is further configured to obtain an indication of the altitude of the wireless device.

The object of providing more flexible neighbour relations of a cell serving a wireless device is according to a sixth embodiment of the invention also achieved by a method of assisting in the handling of neighbour relations for a first cell in a wireless communication network. The method is performed by a wireless device and comprises:

obtaining a number of sets of neighbour relations for the first cell;
selecting, based on the altitude of the wireless device, a set of neighbour relations for the first cell from a number of sets of neighbour relations; and
determining neighbour cells for the wireless device, when the wireless device is being served by the first cell, based on the selected set of neighbour relations.

Each set of neighbour relations that may be selected is also associated with a different altitude interval.

According to a first variation of the sixth embodiment, the method further comprises performing cell reselection based on the determined neighbour cells.

According to a second variation of the sixth embodiment, the method further comprises performing link quality determinations based on the determined neighbour cells.

According to a third variation of the sixth embodiment, the method further comprises obtaining an indication of the altitude of the wireless device.

The object of providing more flexible neighbour relations of a cell serving a wireless device is according to a seventh embodiment of the invention also achieved through a computer program for assisting in handling of neighbour relations for a first cell in a wireless communication network. The computer program comprises computer program code which when run in a wireless device, causes the wireless device to:

obtain a number of sets of neighbour relations for the cell;
select, based on the altitude of the wireless device, a set of neighbour relations for the first cell from a number of sets of neighbour relations; and
determine neighbour cells for the wireless device when the wireless device is being served by the first cell, based on the selected set of neighbour relations.

Each set of neighbour relations that may be selected is also associated with a different altitude interval.

The object is according to an eighth embodiment also achieved through a computer program product for assisting in the handling of neighbour relations for a first cell in a wireless communication network. The computer program product comprises a data carrier with computer program code according to the seventh embodiment.

In a further variation of all the previously mentioned embodiments, the set of neighbour relations define neighbour cells on which the wireless device is to perform measurements and rules defining the use of these neighbour cells.

In another variation of all the previously mentioned embodiments, the sets of neighbour relations are defined based on variations of radio network conditions in the first cell in the direction of altitude variations, such as in a vertical direction.

In yet another variation of all the previously mentioned embodiments, the set of neighbour relations is associated with a user category, with which the wireless device is associated.

Some embodiments have the advantage of allowing more flexibility in the use of neighbour cells and their relations. Thereby it is possible to take account of radio environment variations within a cell, which can be used to obtain a more efficient operation of both the wireless device and the serving cell.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The invention will now be described in more detail in relation to the enclosed drawings, in which:

FIG. 1 schematically shows a horizontal view of an access network of a wireless communication network comprising base stations in cells as well as a wireless device that communicates with the base stations,

FIG. 2 is a schematic diagram showing a number of cells in the access network of the wireless communication network,

FIG. 3 shows a block schematic of the wireless device comprising a first realization of a neighbour relations assisting block,

FIG. 4 shows a block schematic of a second realization of the neighbour relations assisting block,

FIG. 5 shows a block schematic of a third realization of the neighbour relations assisting block,

FIG. 6 shows a block schematic of a neighbour relations handling device comprising a first realization of a neighbour relations handling module,

FIG. 7 shows a block schematic of a second realization of the neighbour relations handling module,

FIG. 8 shows a block schematic of a third realization of the neighbour relations handling module,

FIG. 9 schematically shows a neighbour relations table comprising three sets of neighbour relations,

FIG. 10 schematically shows method steps in a first embodiment of a method for handling neighbour relations for a first cell and being performed by the neighbour relations handling device,

FIG. 11 schematically shows method steps in a second embodiment of a method for handling neighbour relations of a cell being performed by the neighbour relations handling device,

FIG. 12 shows a flow chart of a number of method steps in a first embodiment of a method for assisting the neighbour relations handling device to handle neighbour relations for a first cell and being performed by the wireless device,

FIG. 13 shows a flow chart of a number of method steps in a second embodiment of the method for assisting the neighbour relations handling device to handle neighbour relations for a first cell and being performed by the wireless device,

FIG. 14 shows a computer program product comprising a data carrier with computer program code for implementing functionality of the neighbour relations handling device, and

FIG. 15 shows a computer program product comprising a data carrier with computer program code for implementing functionality of the wireless device.

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits, and methods are omitted so as not to obscure the description of the invention with unnecessary detail.

Some embodiments are concerned with the provision and use of neighbour relations for cells of a wireless communication network. Certain embodiments are more particularly directed towards the provision of such neighbour relations in relation to different altitudes, such as in relation to different heights above a reference height, like ground level. This may be of interest for use with wireless devices that are able to move in a height direction, i.e. the wireless device is moveable and may occupy different altitudes. Examples of such wireless devices are unmanned aerial vehicles (UAVs) and User Equipment (UEs) moving vertically through the use of elevators, gas filled balloons or helicopters.

The wireless communication network may as an example be a mobile communication network like Long-Term Evolution (LTE), Universal Mobile Telecommunications System (UMTS) and Global System for Mobile Communications (GSM) or 5G. The invention will be described below in relation to LTE. However, since most wireless terminals today support several radio access technologies (RAT), the invention may use in any of the existing RATs, such as UMTS, GSM, or CDMA2000, where CDMA is an acronym for Code Division Multiple Access. These are just a few examples of networks where the invention may be used. Another type of network where the invention may be used is a Wireless Local Area Network (WLAN) using the Institute of Electrical and Electronics Engineers (IEEE) 802.11 standard.

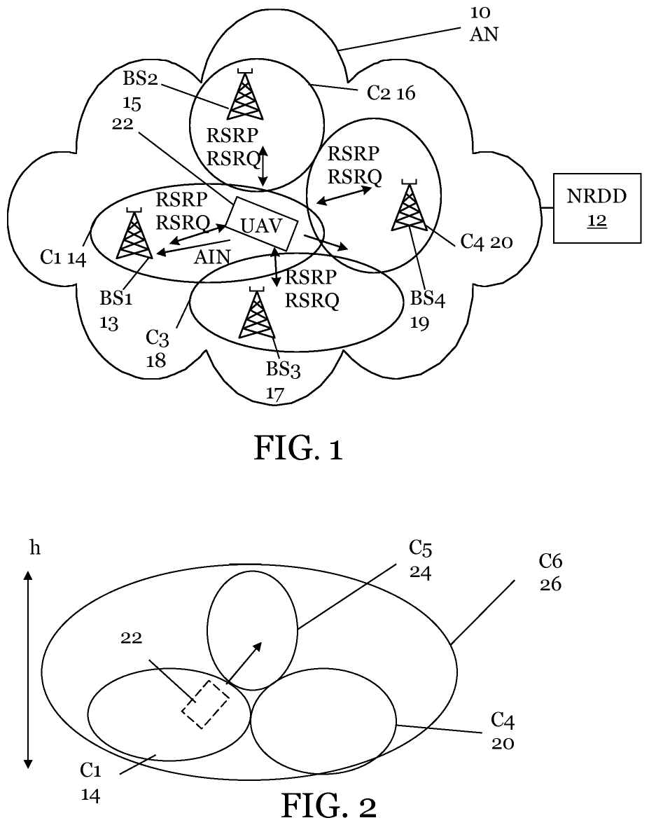

FIG. 1 schematically shows a wireless communication network which may be a network according to any of the above described types. The network may furthermore comprise an access network AN to. In the figure the horizontal extension of the access network to is shown. The access network to is thus here shown in two dimensions, which in this case is in an x-y plane. In this extension the access network to comprises a first radio base station BS1 13 providing coverage of a first cell C114, a second radio base station BS2 15 providing coverage of a second cell C2 16, a third radio base station BS3 17 providing coverage of a third cell C3 18 and a fourth radio base station BS4 19 providing coverage of a fourth cell C4 20. It should here be realized that a base station may provide more than one cell. In an LTE implementation, the base station would be an eNB or eNodeB.

In FIG. 1 there is also shown a moveable wireless device, i.e. a wireless device that is capable of moving around. In this example it is a vessel or vehicle in the exemplifying form of an UAV 22. The UAV 22 is indicated as being located within the first cell 14 and set to move in the direction of the fourth cell 20. Furthermore, it can be seen that the UAV 22 is communicating with all of the base stations 13, 15, 17 and 19. The communication being indicated in FIG. 1 is here shown in the form of radio link quality measurements or radio link quality determinations being exemplified by Reference Signal Received Power (RSRP) and Reference Signal Received Quality (RSRQ). The UAV 22 is also shown as providing the first base station 13 with an indication MN of its altitude. This indication will in the following be named an altitude indication.

Finally it can be seen that there is a neighbour relations determining device NRDD 12 connected to the access network 10. The neighbour relations determining device 12 is in many wireless communication networks an Operations and Maintenance (OAM) node, which is typically provided in a core network (not shown) of the wireless communication network.

In the wireless communication network there is also provided a device for handling neighbour relations of a cell. This device will in the following be termed a neighbour relations handling device. The neighbour relations handling device may as an example be provided in a base station, for instance in the first base station 13. However, it may as an alternative be provided as another node in the network, such as a node with which such a base station communicates, like a Mobility Management Entity (MME) or a Serving GPRS Support Node (SGSN), where GPRS is an acronym for General Packet Radio Service. The neighbour relations handling device may also be provided in a datacentre in the cloud as a cloud computing function that for instance the first base station 13 accesses. The functionality may even be located in the core network. What is important though is that a base station that acts as a serving base station for a wireless device accesses neighbour relations sets provided by such a neighbour relations handling device.

FIG. 2 schematically shows a height extension of the access network of the wireless communication network i.e. in the height direction h or xz plane of the access network. The UAV 22 is here indicated as being in the first cell 14 close to the border to the fourth cell 20. However, there is in this figure also a fifth cell C5 24 above the first and fourth cells 14 and 20 in the height direction and a sixth umbrella cell C6 26 covering the first, fourth and fifth cells 14, 20 and 24. It can also be seen that the UAV 22 is in fact moving into the fifth cell 24 and not into the fourth cell 20.

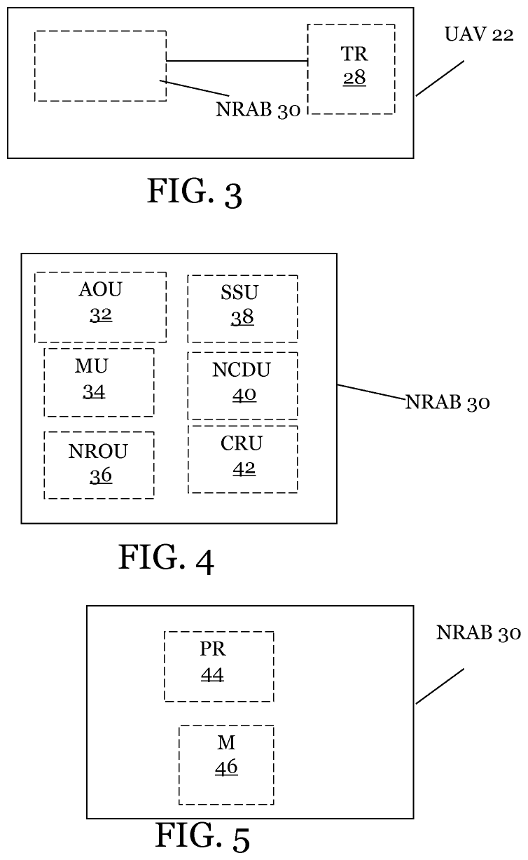

FIG. 3 shows a block schematic of some of the content of the UAV 22. The UAV 22 comprises a wireless transceiver TR 28 set to communicate according to a wireless communication standard employed by the wireless communication network, which in this case may be LTE. The UAV 22 also comprises a neighbour relations assisting block NRAB 30.

There are a number of ways in which a neighbour relations assisting block may be realized and FIG. 3 shows a first such realization. In this first realization, the neighbour relations assisting block 30 is provided as processing circuitry, for instance as an Application Specific Integrated Circuit (ASIC) or Field-Programmable Gate Arrays (FPGA), the functionality of which will be described later on.

FIG. 4 shows a block schematic of a second realization of the neighbour relations assisting block NRAB 30. It comprises an altitude obtaining unit AOU 32, a measurement unit MU 34, a neighbour relations obtaining unit NROU 36, a set selecting unit SSU 38, a neighbour cell determining unit NCDU 4o and a cell reselecting unit CRU 42. It is in this case possible that the altitude obtaining unit 32, the measurement unit 34, the neighbour relations obtaining unit 36 and cell reselecting unit 42 are all connected to the transceiver (not shown).

It can furthermore be mentioned that it is possible that in some variations, the set selecting unit 38, the neighbour cell determining unit 40 and the cell reselecting unit 42 may be omitted.

The units of the neighbour relations assisting block 30 may be provided as software blocks, for instance as software blocks in a program memory, but also in this case as processing circuitry or hardware blocks for instance as one or more dedicated special purpose circuits, such as ASICs and FPGAs.

FIG. 5 shows a block schematic of a third realization of the neighbour relations assisting block 30. It may in this case be provided in the form of a processor PR 44 connected to a program memory M 46. The program memory 46 may comprise a number of computer instructions implementing the functionality of the neighbour relations assisting block and the processor 44 implements this functionality when acting on these instructions. It can thus be seen that the combination of processor 44 and memory 46 thereby provides processing circuitry implementing the neighbour relations assisting block 30.

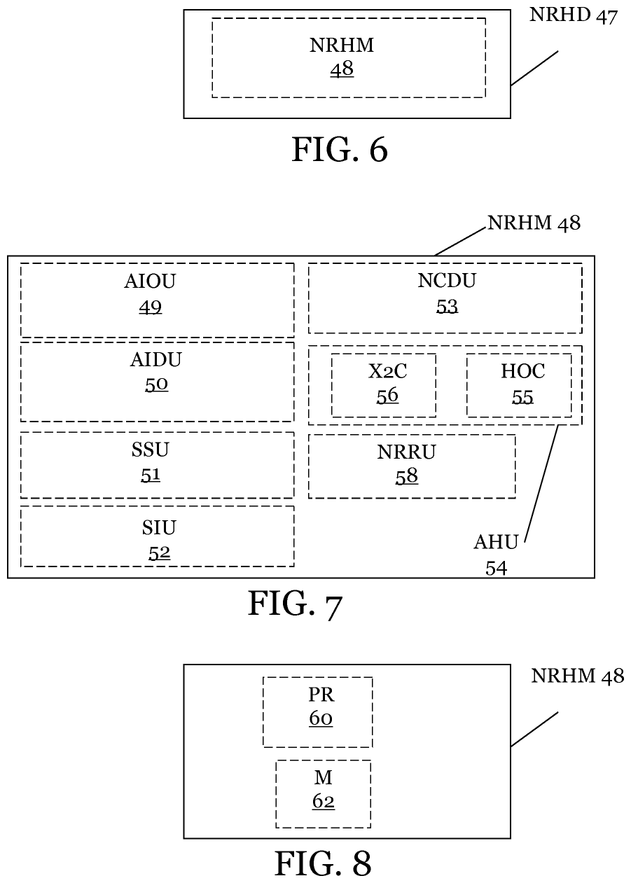

FIG. 6 shows a block schematic of the neighbour relations handling device NRHD 47. The neighbour relations handling device 47 comprises a neighbour relations handling module NRHM 48. The figure more particularly shows a first realization of the neighbour relations handling module 48 provided as processing circuitry for instance as an ASIC or FPGA, the functionality of which will be described later on.

FIG. 8 shows a second realization of the neighbour relations handling module NRHM 48, which comprises an altitude indication obtaining unit AIOU 49, an altitude interval determining unit AIDU 50, a set selecting unit SSU 51, a set informing unit SIU 52, a neighbour cell determining unit 53, an activity handling unit AHU 54 and a neighbour relations receiving unit NRRU 58. The activity handling unit 54 here comprises an X2 control block X2C 56 and a handover control block HOC 55.

The units in FIG. 7 may also be provided as software blocks for instance as software blocks in a program memory, but also through processing circuitry or hardware blocks, such through one or more dedicated special purpose circuits, such as ASICs and FPGAs.

FIG. 8 shows a third way of realizing the neighbour relations handling module NRHM 48. It may be provided in the form of a processor PR 6o connected to a program memory M 62. The program memory 62 may comprise a number of computer instructions implementing the functionality of the neighbour relations handling device 47 and the processor 6o implements this functionality when acting on these instructions. It can thus be seen that the combination of processor 6o and memory 62 forms processing circuitry providing the neighbour relations handling device 47.

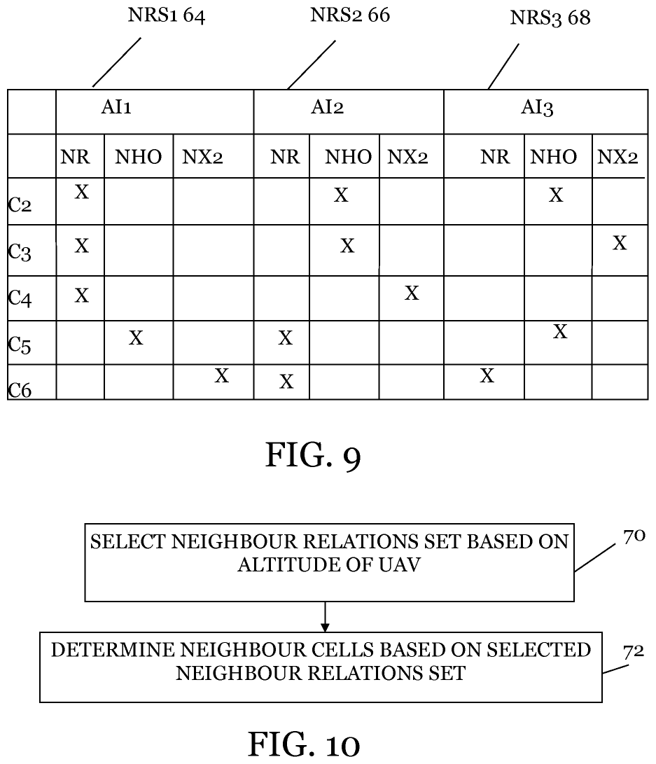

FIG. 9 shows one example of a neighbour relations table (NRT) provided for a cell and used in variations of the invention. The neighbour relations table comprises rules or relations for a cell of the wireless communication network in relation to its neighbours. It more particularly defines neighbour cells on which wireless devices are to perform measurements and rules defining the use of these neighbour cells.

The table shown in FIG. 9 is provided for the above-mentioned first cell. Therefore the relations are relations between this cell and its neighbours as shown in FIGS. 1 and 2. It should be realized that such a table may be provided also for other cells in the wireless communication network

The relations are furthermore organized in sets, where each set of neighbour relations is provided for or is associated with a corresponding altitude interval. Thereby a set of neighbour relations is provided for an interval of altitudes of a wireless device above ground. A set of neighbour relations will in the following be termed a neighbour relations set. The different neighbour relations sets may also be provided in individual neighbour relation tables. Alternatively all sets of neighbour relations may be provided in a common neighbour relations table.

In the example in FIG. 9 there is a first neighbour relations set NRS1 64 associated with a first altitude interval AI1, a second neighbour relations set NRS2 66 associated with a second altitude interval AI2 and a third neighbour relations set NRS3 associated with a third altitude interval AI3. The first altitude interval AI1 may in this case range from zero to a first altitude A1, the second altitude interval AI2 may range from the first altitude A1 to a second altitude A2 and the third altitude interval AI3 may range from the second altitude A2 to a third altitude A3, where the third altitude A3 may be higher than the second altitude A2, which in turn may be higher than the first altitude A1 and where all altitudes may also be related to a ground level.

Moreover, each of these sets out neighbour relations, which are the relations between a serving cell and its neighbour cells. In this example, the serving cell for which the neighbour relations are provided is the first cell. The relations are thus provided in respect of the neighbours of the first cell, which in the example of FIGS. 1 and 2 are the second cell C2, the third cell C3, the fourth cell C4, the fifth cell C5 and the sixth cell C6. In FIG. 9 it can be seen that there are relations between the first cell C1 and all of the neighbours in all of the sets NSR1, NSR2 and NSR3. However, it should be realized that it is possible that one or more of the sets do not have relations for all neighbours. Put differently it is possible that a set lacks one or more of the totality of neighbours. It should also be realized that there may be more but also fewer sets associated with a serving cell.

In FIG. 9 a number of specific relations or rules are shown in relation to the neighbours. These rules indicate how the neighbour cells are to be handled in the wireless communication network. One rule may in this case be No Remove NR, which means that the neighbour in question is not allowed to be removed from the set. Another rule is No HandOver NHO, which means that handover is not allowed between the serving cell and the neighbour in question. A third rule is No X2, NX2, which means that no X2 connection is allowed to be set up between the serving cell and the neighbour in question. These are just some examples of rules that are commonly used in wireless communication networks. It should be realized that it is possible also with other rules. It is also possible that only one or some of the above mentioned rules are used in a neighbour relations set.

As can be seen in FIG. 9 there are different settings of these rules in the different sets. It can for instance be seen that in the first set NRS1, the second, third and fourth cells C2, C3 and C4 are set as not being allowed to be removed (NR), the fifth cell C5 is set as not being allowed to be involved in handover (NHO) and the sixth cell C6 is set as not being allowed to be connected to the first cell via an X2 connection (NX2). In the second set NRS2, the fifth and sixth cells C5 and C6 are set as not being allowed to be removed NR, the second and third cells C2 and C3 are set as not being allowed to be involved in handover NHO and the fourth cell C4 is not allowed to be connected to the first cell via an X2 connection NX2. In the third set NRS3, the sixth cell C6 is set as not being allowed to be removed NR, the second and fifth cells C2 and C5 are set as not being allowed to be involved in handover NHO and the third cell C3 is set as not being allowed to be connected to the first cell via an X2 connection NX2.

As mentioned above, the UAV 22 is a wireless device that is a flying vessel. Therefore it is possible that it may occupy different altitudes, where the altitude may be an altitude above ground.

Typical UEs of today are handsets which are commonly used on ground (street) level.

Neighbour cell relations, e.g. such as to block handover, etc., are a function of the radio environment that the UE operates in. In that context, shadow fading characteristics such as Mocking or partial Mocking from buildings, ground level topology and foliage are critical factors.

As a consequence, the practical shadow fading and blocking environment, i.e. and to what extent that contributes to what cells that are seen by a wireless device as a “neighbouring cell” may differ depending on whether the wireless device is “low down on the ground” or “slightly above rooftops” or “airborne completely away from building shadowing”.

In a scenario where an airborne UE goes over a rooftop, other cell relations may be detected than typically identified on ground level. By changing the altitude, an UAV could therefore potentially detect many cells that previously have been hidden by buildings.

The higher the altitude, the more an actual neighbour cell relation list may differ from a set of optimal cell relations. More specifically, the altitude of a wireless device should contribute to what neighbour relations are considered for that specific wireless device.

Moreover, as UAV traffic is emerging, UAV/UE generated handover will be more frequent and should be properly taken care of in the network operation.

Aspects of the invention are concerned with such neighbour relations that depend on the altitude of the wireless device.

A first embodiment of a method of handling neighbour relations being performed by the neighbour relations handling device will now be described with reference also being made to FIG. 10, which shows a number of method steps being performed by the neighbour relations handling device 47 for a serving cell, which serving cell as an example is the first cell 14 being provided by the first base station 13.

As mentioned above the device 47 may therefore be implemented in or as this first base station 13 or as a device with which the first base station 13 communicates, such as another network node of the wireless communication network or as a cloud computing device in a server centre.

The wireless device, which as an example is the UAV 22, is in this case served by the first cell 14. The UAV 22 is then also performing measurements such as RSRP and/or RSRQ measurements on the neighbours of the first cell. However, in order to do this it may need to know which cells that are neighbours. The neighbour relations handling device 47 that handles the neighbour relations in turn determines which cells that are neighbours to the first cell as well as provides the rules for how these neighbours are to be handled. As was described above the radio network conditions may differ considerably for different altitudes within the serving cell. It may therefore be necessary to provide different neighbour relations sets for different altitudes, which means that the cells that the UAV 22 is to perform measurements on as well as the way the neighbour cells are to be handled may differ for different altitudes. The first embodiment addresses at least some of these issues.

The neighbour relations handling device 47 keeps the neighbour relations, such as the neighbour relations shown in FIG. 9, for the different altitude intervals AI1, AI2, AI3. The neighbour relations may as an example be kept in the form of one or more neighbour relations tables (NRTs). The altitude intervals are intervals within which altitudes of various wireless devices may lie when the wireless device is communicating with the first cell 14. The UAV 22 thus has a certain altitude as it is being served by the first cell 14.

The neighbour relations handling module 48 selects, based on this altitude of the UAV 22, a neighbour relations set for the first cell 14 from a number of neighbour relations sets, step 70, where each set is associated with a different altitude interval.

It thus selects one of the neighbour relations sets NRS1, NRS2 and NRS3 corresponding to the altitude of the wireless device 22.

There are a number of ways in which the neighbour relations handling device 47 may obtain information of this altitude.

The altitude may for instance be reported by the UAV 22 to the neighbour relations handling device 47, which may be done through the neighbour relations assisting block 30 of the UAV 22 reporting the altitude to the first base station 13, for instance through sending an altitude indication MN via the transceiver 28 to the first base station 13, where it may be made accessible to the neighbour relations handling device 47. As an alternative it is possible that some other network node obtains the altitude of the UAV 22 and reports it to the neighbour relations handling device 47. The altitude may then be compared, by the neighbour relations handling module 48, with altitude thresholds in order to find out in which altitude interval the altitude lies.

In the example given here the altitude may be an altitude in the range between the second and third altitudes A1 and A2 and therefore the neighbour relations handling module 48 selects the second neighbour relations set NRS2.

When the neighbour relations set has been selected, the neighbour relations handling module 48 determines the neighbour cells for the UAV 22 based on the selected neighbour relations set, step 72. It may thus select the cells that are included in the selected neighbour relations set to be the neighbours of the first cell at the altitude of the UAV 22. It may thus select the cells of the set for which neighbour relations are defined to be the neighbour cells. It may also exclude cells for which handover is not allowed.

The selected set may also be reported to the UAV 22 in order for the UAV 22 to perform measurements on the cells. It therefore informs the UAV about the selected neighbour relations set NRS2. It is possible that all the neighbour relations sets NRS1, NRS2 and NRS3 are being sent to the UAV 22, for instance at the time of initial serving in order to inform the UAV of the content of all neighbour relations sets. The UAV 22 may in this case be informed of which specific neighbour relations set to use at a later stage, i.e. in relation to the reporting of a certain altitude. As an alternative it is possible that the selected neighbour relations set 66 is transferred to the UAV 22, for instance as a result of the obtaining of a altitude indication AIN. The UAV 22 may thus in this case be informed about the selection of the selected neighbour relations set as well as its content. It is furthermore possible that the UAV 22 is not informed of the selected neighbour relations set at all.

The neighbour relations assisting block 30 of the UAV 22 may then report measurements, such as RSRP and RSRQ measurements, to the first base station 13 via the transceiver 28, where the measurements may be measurements only on the neighbours in the selected neighbour relations set NRS2. In case no information of set selection is given, the measurements may be performed on all neighbours defined by all sets that the UAV 22 is able to find.

The neighbour relations handling module 48 may in turn use the neighbour relations set for activities performed by the first cell 14 for the UAV 22. It is for instance possible that the NX2 rules of the set and the NHO rules of the set are applied on the cells. In the given example this may mean that no X2 connections are allowed to be set up to the fourth cell 20 and no handover is allowed to be made to the second and third cells 16 and 18. The neighbour relations set may also be used for priorities in activities being performed, such as prioritizing between cells in handover.

In case the second realizations of the neighbour relations assisting block 3o and the neighbour relations handling module 48 are used, the reporting of the altitude by the UAV may be made by the altitude obtaining unit 32 to the altitude indication obtaining unit 49, the comparison of the altitude with altitude thresholds may be made by the altitude indication determining unit 50, the selecting of a neighbour relations set may be performed by the set selecting unit 51, the determining of neighbour cells for the UAV 22 may be made by the neighbour cell determining unit 53 and the reporting of the selected set to the UAV 22 may be made by the set informing unit 52.

The measurement unit 34 of the UAV 22 may thereafter report measurements and the activity handling unit 54 may use the neighbour relations set for the activities performed by the first cell 14 for the UAV 22, where the X2 control block 56 may apply the NX2 rules and the handover control block 55 may apply the NHO rules.

Thereby it is possible for the neighbour relations handling device 47 to use altitude information to distinguish beneficial cell relations for wireless devices operating at different altitudes. The neighbour relations sets may more particularly be defined based on the variations of the radio network conditions of the serving cell in the vertical direction. It is thereby possible to consider varying radio conditions at different altitudes in activities performed by the serving cell, such as in performing of handover. Thereby these activities may be performed more efficiently.

According to aspects of the invention the neighbour relations sets may be used for collecting measurements with respect to altitude. Such measurements, which are linked to an altitude, may then be used for predicting handover and load balancing. Handover and load balancing may thereby be predicted depending on how a wireless terminal moves in three-dimensions.

As was mentioned earlier, the use of neighbour relations sets is not limited to UAVs, but is also possible for other wireless devices, such as Internet of Things (IoT) devices like sensors on moving objects such as on gas-filled balloons or helicopters. The wireless device may also be a portable wireless device like a smart phone. In this case it is possible that different altitude intervals are used if for instance a user with a portable wireless device is moving upwards or downwards in an elevator a gas filled balloon or a helicopter.

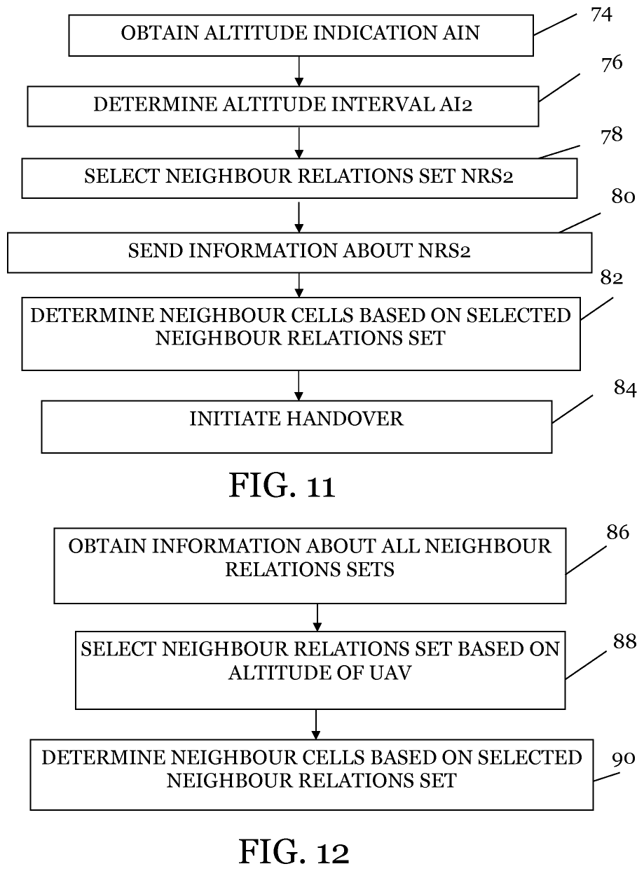

Now a second embodiment of the handling of neighbour relations will be described with reference also being made to FIG. 11, which shows a number of method steps being performed by the neighbour relations handling device 47.

As in the first embodiment the neighbour relations handling device 47 keeps the neighbour relations, such as the neighbours relations shown in FIG. 9, for the different altitude intervals AI1, AI2 and AI3. The neighbour relations are thus provided for wireless devices communicating with or being served by the first cell 14, where the altitudes of the various wireless communication devices may lie within these altitude intervals.

In this situation it is possible that the UAV 22 is being served by the first cell 14. In order for the appropriate neighbour relations set to be used, the UAV 22 may then send information about its altitude to the neighbour relations handling device 47.

Therefore the UAV 22 may send an altitude indication AIN to the first base station 13 via the transceiver 28, which altitude indication MN is then handled in the first base station 13 in case it itself forms or comprises the neighbour relations handling device 47. However, in case the neighbour relations handling device 47 is provided elsewhere like in another network node or in a cloud computing device, then the first base station 13 forwards the altitude indication AIN to this device.

It is here possible that the UAV 22 has a sensor that senses the height. Alternatively it may be able to obtain the altitude from external systems such as using GPS positioning system, where GPS is an acronym for Global Positioning System.

It is furthermore possible that the altitude indication MN is sent as a part of a standardized procedure of the first cell 14 to get information from the UAV 22. It is for instance possible that a request for information, UEInformationRequest, sent by the Evolved UTRAN (EUTRAN) according to 3GPP standard, comprises a request for the height of the UAV and that the response, UEInformationResponse, includes the height indication AIN. Here it may also be mentioned that UTRAN is an acronym for Universal Terrestrial Radio Access Network. As is known, such a response may comprise more information such as various measurements made on various base stations with which the UAV 22 may be able to connect.

The altitude indication MN is then obtained or received by the neighbour relations handling module 48 of the neighbour relations handling device 47, step 74, which thereafter investigates which altitude that the UAV 22 has reported and then determines within which altitude interval it lies, step 76. In the example given here the altitude interval is the second altitude interval AI2.

Thereafter the neighbour relations handling module 48 selects a neighbour relations set that corresponds to the altitude interval, step 78, which in the given example is the second neighbour relations set NRS2. Thereby the selection is performed based on the altitude indication.

The selected set NRS2 is then reported to the UAV 22 in order for the UAV 22 to perform measurements on the cells. The neighbour relations handling module 48 thus sends information about the selected neighbour relations set NRS2 to the UAV 22, step 80, where it is again possible that all the neighbour relations sets NRS1, NRS2 and NRS3 are being sent to the UAV 22 or that only the selected set is sent.

When all neighbour relations sets are being sent, then these may be sent when the UAV 22 is initially being served followed by only sending an indication of which set has been selected for a reported altitude. Alternatively such an indication as well as the content of the selected neighbour relations set may be sent simultaneously for instance as a response to a reported altitude.

The neighbour relations assisting block 30 of the wireless device 22 may then report measurements to the first base station via the transceiver 28, where the measurements may be measurements such as RSRP and RSRQ only made on the neighbours in the selected neighbour relations set NRS2 or in case no information about set selection is given, on all neighbours defined by all sets. It is in this regard possible that the rules of the selected set are applied on how the measuring and reporting is made.

Measurements and reporting may for instance be made more frequently for a neighbour cell that is not allowed to be removed from the set and less frequently for a neighbour cell to which X2 connections are not allowed. It is furthermore possible that measurements and reporting are not made at all for neighbour cells to which handover is not allowed.

The neighbour relations handling module 48 also determines the neighbour cells for the UAV 22 based on the selected neighbour relations set, step 82. It may thus select the cells that are included in the selected neighbour relations set to be the neighbours of the first cell at the altitude of the wireless device. It is here also possible that the neighbour cell to which no handover is allowed is excluded as a neighbour.

It should be realized that the order in which the informing of the neighbour relations set selection and the determining of the neighbour cells is made is not critical. Either one of these activities may be performed before the other. They may also be performed simultaneously.

The neighbour relations handling module 48 may then use the neighbour relations set for activities performed by the first cell 14 for the UAV 22. It may more particularity initiate handover of the UAV 22 from the first cell 14 to one of the determined neighbour cells if this is required, step 84. Furthermore, in this handover the neighbour relations handling module 48 applies the NHO rules of the set. This means that neighbour cells to which no handover is allowed are excluded from the handover. This also means that in the given example it is possible to hand over the wireless device 22 to the fourth, fifth or sixth cells 20, 24 and 26, but not to the second and third cells 16 and 18. No handover is thus allowed to be made from the first cell 14 to the second and third cells 16 and 18. As can be seen in FIG. 2, a handover to the fifth cell 24 would be advantageous. It is also possible that the neighbours are given different weights in the determining of which cell to perform handover to because of the neighbour relations. A cell having an NR setting may for instance receive a higher weight than a cell that lacks such a setting. A cell with an NX2 setting may in a similar manner have an even lower weight.

It is of course possible that also the other rules are applied in activities of the neighbour relations handling device 47. The disallowing of the use of X2 connections to neighbour cells and barring removal of cells from the set may also be implemented. In the given example no X2 connections are thus allowed to be set up between the first and the fourth cell 14 and 20. The first and the fourth base stations 13 and 19 are therefore not allowed to communicate directly with each other.

It can in this way be seen that as the UAV 22 detects a new serving cell, given that the wireless communication network knows the current altitude of the UAV 22, different neighbour cells and rules can be used for the UAV 22. Thereby the network can select how to more efficiently handle the corresponding cell relations. This would as an example enable that e.g. an UAV above rooftop can follow better optimized HO rules given the radio propagation environment at its operational altitude.

In the embodiments described above, the neighbour relations handling device 47 selected the set of neighbour relations and performed the determination of neighbour cells based on the selected set. However, in some cases it is possible that the wireless device performs these activities. This is especially the case if the wireless device being served by the first cell is in idle mode.

A first embodiment of assisting in the handling of neighbour relations will now be described with reference also being made to FIG. 12, which shows a number of steps in a method of assisting the neighbour relations determining device 47 in the handling of neighbour relations, which method is being performed by the UAV 22 and then more particularly by the neighbour relations assisting block 30 of the UAV 22.

The method starts by the neighbour relations assisting block 30 of the UAV 22 obtaining all the neighbour relations sets NRS1, NRS2 and NRS3 for the first cell 14 from the neighbour relations handling device, step 86. This may be done through the neighbour relations handling module 48 of the neighbour relations handling device 47 informing the UAV 22 about all the sets NRS1, NRS2 and NRS3, for instance at the point in time when the UAV 22 starts to be served by the first cell 14.

All the neighbour relations sets 64, 66 and 68 may in this way be received by the neighbour relations assisting block 30.

It then selects, based on the altitude of the UAV 22, a set of neighbour relations for the first cell 14 from the above-mentioned sets of neighbour relations, step 88.

In order to do this the neighbour relations assisting block 30 may first obtain the altitude indication, which may be through the first cell 14 reporting an altitude determination being made in a node of the wireless communication network or through it itself determining the altitude.

It is also in this case possible for the neighbour relations assisting block 30 to determine within which altitude interval the obtained altitude lies and thereafter select set.

The neighbour relations assisting block 30 thus selects one of the neighbour relations sets NRS1, NRS2 and NRS3 corresponding to the altitude of the wireless device 22. As an example the second neighbour relations set NRS2 is selected.

The neighbour relations assisting block 30 then determines neighbour cells for the UAV 22 when it is served by the first cell 14 based on the selected set, step 9o, where this determination may be made in the same way as was described in relation to the handling of neighbour relations being performed by the neighbour relations handling device 47.

The neighbour relations assisting block 30 may thus determine that the cells that are included in the selected neighbour relations set are to be considered as neighbours of the first cell 14 at the altitude of the UAV 22. The neighbour relations assisting block 30 may thus select the cells of the set for which neighbour relations exist to be the neighbour cells. In this determination it is likewise possible that the cells for which there is a setting of NHO are being excluded as neighbours.

The selected neighbour relations set may then be used for various activities of the UAV 22, such as cell reselection or the performing of signal quality measurements. Cell reselection as well as link quality determinations may thus be performed based on the determined neighbour cells. It is more particularly possible that idle mode cell resection is only allowed to be made to cells in the set to which handover is allowed. It is also here possible with a weighting being performed with regard to the settings like NR and NX2 when performing cell reselection. It is also possible that for some of the neighbour relations settings, link quality determinations are made less frequently than for others. It is for instance possible that no or very infrequent measurement are made to cells for which there is a NHO setting, that measurements are made a bit more frequently for cells with a NX2 setting and that measurements are made most frequently for cells with a NR setting.

In case the second realizations of the neighbour relations assisting block 3o and the neighbour relations handling module 48 are used, the set informing unit 52 of the neighbour relations handling device 47 may inform the neighbour relations obtaining unit 36 of the UAV 22 about the sets NRS1, NRS2 and NRS3. The set selecting unit 38 may then select a set of neighbour relations based on an altitude indication obtained by the altitude obtaining unit 32, the neighbour cell determining unit 40 may determine neighbour cells for the UAV 22 and that the cell reselection unit 42 may perform cell reselection based on the selected set.

It can in this way be seen that the rules of the selected set NRS2 are applied on activities that are performed by the UAV, which activities may involve activities of the neighbour relations assisting block 30, which in the case of the above mentioned second variations may be activities of the measurement unit 34 and the cell reselection unit 42. Thereby it is also possible to improve the efficiency of such activities as cell reselection.

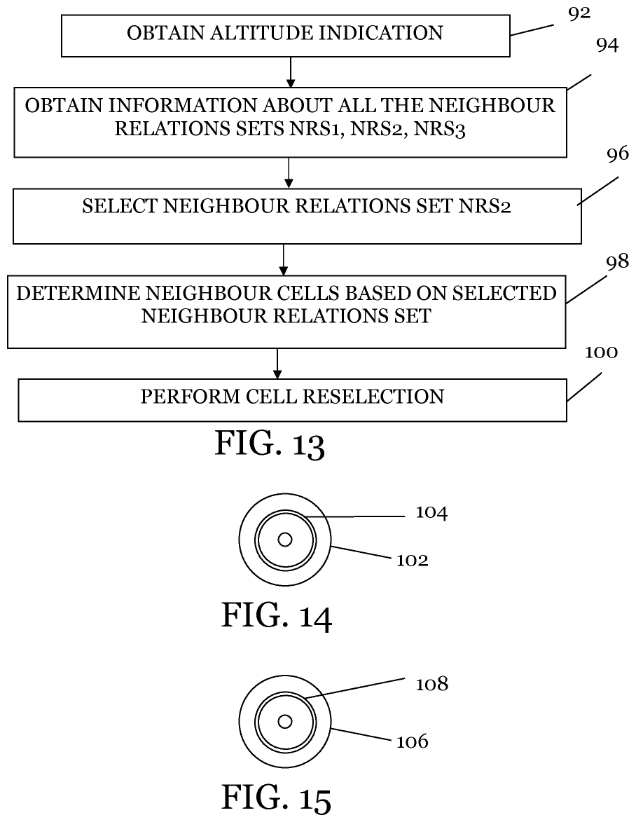

Now a second embodiment of assisting in the handling of neighbour relations will be described with reference also being made to FIG. 13, which shows a number of method steps being performed by the UAV 22.

The method may start by the neighbour relations assisting block 30 of the UAV 22 obtaining an altitude indication, step 92, which in this embodiment is done through it itself determining the altitude. This may be done through obtaining the altitude above ground using for instance GPS. Other possible ways are through using a gyro or accelerometer.

The neighbour relations assisting block 30 also obtains information about all the neighbour relations sets NRS1, NRS2 and NRS3 from the neighbour relations handling device 47, step 94. This may be done through the neighbour relations assisting block 30 receiving all the neighbour relations sets NRS1, NRS2 and NRS3 from the neighbour relations handling device 47, for instance at the point in time at which the UAV 22 starts being served by the first cell 14.

The neighbour relations assisting block 30 of the UAV 22 then selects, based on the altitude of the UAV 22, a neighbour relations set for the first cell 14 from said sets of neighbour relations, step 96, and in the example given here selects the second set NRS2.

It thus selects one of the neighbour relations sets NRS1, NRS2 and NRS3 corresponding to the altitude of the wireless device 22.

The neighbour relations assisting block 30 then determines neighbour cells for the UAV 22 when it is served by the first cell 14 based on the selected set, step 98, where this determination may be made in the same way as was described in relation to the previous embodiments.

The neighbour relations assisting block 30 may thus select the cells that are included in the selected neighbour relations set NRS2 to be the neighbours of the first cell 14 at the altitude of the UAV 22. It may thus select the cells that exist in the set NRS2 to be neighbours. In this determination it is likewise possible that the cells for which there is an NHO setting are being excluded as neighbours.

The selected neighbour relations set NRS2 is then used by the neighbour relations assisting block 30 in the performing of cell reselection being made in idle mode, step 100. This may involve only allowing cell reselection to be made to cells in the set to which handover is allowed. It may also be used to give preference to cells that are not allowed to be removed. Priority may thus be given to cells that are not allowed to be removed from the set. It is also possible to give a lower priority to cells for which not X2 settings have been made.

It can in this way be seen that a more effective cell reselection may be obtained than if all actual neighbours of the serving cell are considered.

It may here also be mentioned that the traditional neighbour relations activities may also be performed. A wireless device, like the UAV, may report new cells for a given altitude and the neighbour relations handling device may add these cells to corresponding sets. The UAV may thus report cell identifiers of newly discovered cells not in the set such as Central Global Identifiers (CGIs) without prompting from the neighbour relations handling device or the first base station.

This may be done in the way specified by 3GPP TS36.300 v14.1.0 (2016-12), section 22.3.2a Automatic Neighbor Relation Function; which is herein incorporated by reference. The various steps being performed for a neighbour relations set being implemented as a Neighbour Relations Table (NRT) may thus be:
The serving base station instructs the UAV to take measurements of neighbouring cells on a periodic basis (inter/intra cell)
In that, the UAV can detect a cell identifier such as Physical Cell identity (PCI) not listed in the NRT.
In the measurement report to the serving base station, the UAV includes cell identity, including also the “new” one
After receiving that measurement report, the serving base station tells the UAV to report also new cell's ECGI (E-UTRAN Cell Global Identifier), while reading the Broadcast Control Channel (BCCH) of the “new” cell.
   UAV reports ECGI of “new” cell
   Serving base station updates its NRT
      For each cell:
      Neighbour Relation (NR)←Target Cell Identifier (TCI) comprising ECGI and PCI

Here it may also be mentioned that the rules that are to be applied between two cells are typically not determined by the neighbour relations handling device 47, but by the neighbours relation determining device 12. Therefore the neighbour relations handling module 48 and in the case of the second realization thereof the neighbour relations receiving unit 58, may inform the neighbour relations determining device 12 about the cells that have been reported by wireless devices, perhaps together with related altitudes and link quality measurements.

The neighbour relations determining device 12 may then determine different altitude intervals where similar radio conditions exist for the cells, and then determine, for each altitude interval, which neighbour relations that are to be applied, for instance which cells that are not allowed to be deleted from the set, which cells for which handover is disallowed and which cells for which X2 connections are to disallowed. After having defined the neighbour relations sets for the cell, these are then sent from the neighbour relations determining device 22. The neighbour relations sets are then received by the neighbour relations assisting block 30, and in case of the second realization thereof by the neighbour relations receiving unit 58, and stored for use with wireless devices that are served by the first cell.

It is here also possible that the number of altitude intervals differ between cells. It is for instance possible that the fourth cell has fewer and longer altitude intervals than the first cell. The reason for this is that radio condition variations in the fourth cell may be less dramatic than in the first cell. There may for instance be fewer or not as high buildings causing less variations as in the first cell and thus the number of intervals may be limited.

It is also possible that the use of several neighbour relations sets for a serving cell is associated with a subscription or user category used for a wireless device. UAVs may for instance have a different type of subscription to the use of the wireless communication network than other wireless devices. It is then possible that the use of neighbour relations handling based on altitude is associated with or linked to this type of UAV subscription, while a regular UE subscription has a traditional NRT use. This may be linked to a Subscriber Identity Module (SIM) card used in the UAV. Thereby the neighbour relations sets are associated with a user category which the UAV in turn is associated with.

The computer program code of the neighbour relations handling device may be in the form of computer program product for instance in the form of a data carrier, such as a CD ROM disc or a memory stick. In this case the data carrier carries a computer program with the computer program code, which will implement the functionality of the above-described neighbour relations handling device. One such data carrier 102 with computer program code 104 is schematically shown in FIG. 14.

The computer program code of the neighbour relations assisting block may also be in the form of computer program product for instance in the form of a data carrier, such as a CD ROM disc or a memory stick. In this case the data carrier carries a computer program with the computer program code, which will implement the neighbour relations assisting block. One such data carrier 106 with computer program code 108 is schematically shown in FIG. 15.

The processing circuitry of the neighbour relations handling device may furthermore be considered to comprise means for selecting, based on the altitude of a wireless device being served by the first cell, a set of neighbour relations for the first cell from a number of sets of neighbour relations, where each set is associated with a different altitude interval; and means for determining neighbour cells for the wireless device based on the selected set of neighbour relations.

The processing circuitry of the neighbour relations handling device may also be considered to comprise means for obtaining an indication of the altitude of the wireless device and means for performing the selection based on the indication.

The processing circuitry of the neighbour relations handling device may additionally be considered to comprise means for informing the wireless device of the selected set of neighbour relations, which means for informing may additionally be considered to comprise means for informing the wireless device of the content of the selected set of neighbour relations.

The processing circuitry of the neighbour relations handling device may also be considered to comprise means for informing the wireless device of the content of all the sets of neighbour relations as well as means for initiating a handover of the wireless device from the first cell to one of the determined neighbour cells.

The processing circuitry of the wireless device may also be considered to comprise

means for obtaining a number of sets of neighbour relations for the first cell, where each set is associated with a different altitude interval;
means for selecting, based on the altitude of the wireless device, a set of neighbour relations for the first cell from a number of sets of neighbour relations, where each set is associated with a different altitude interval; and
means for determining neighbour cells for the wireless device, when the wireless device is being served by the first cell, based on the selected set of neighbour relations.

The processing circuitry of the wireless device may also be considered to comprise means for performing cell reselection based on the determined neighbour cells.

The processing circuitry of the wireless device may furthermore be considered to comprise means for making link quality determinations based on the determined neighbour cells.

The processing circuitry of the wireless device may additionally be considered to comprise means for obtaining an indication of the altitude of the wireless device.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the invention is only to be limited by the following claims.

1-26. (canceled)

27. A device for handling neighbor relations of a first cell in a wireless communication network, the device comprising:
processing circuitry;
memory containing instructions executable by the processing circuitry whereby the device is operative to:
select, based on an altitude of a wireless device being served by the first cell, a set of neighbor relations for the first cell from a number of sets of neighbor relations, where each set is associated with a different altitude interval; and
determine neighbor cells for the wireless device based on the selected set of neighbor relations.

28. The device of claim 27, wherein the instructions are such that the device is operative to obtain an indication of the altitude of the wireless device and perform the selection based on the indication.

29. The device of claim 27, wherein the set of neighbor relations define neighbor cells on which the wireless device is to perform measurements and rules defining their use.

30. The device of claim 27, wherein the instructions are such that the device is operative to inform the wireless device of the selected set of neighbor relations.

31. The device of claim 30, wherein the instructions are such that the device is operative to, when informing the wireless device of the selection, also inform the wireless device of the content of the selected set of neighbor relations.

32. The device of claim 27, wherein the instructions are such that the device is operative to inform the wireless device of the content of all the sets of neighbor relations.

33. The device of claim 27, wherein the instructions are such that the device is operative to initiate a handover of the wireless device from the first cell to one of the determined neighbor cells.

34. The device of claim 27, wherein the set of neighbor relations is associated with a user category with which the wireless device is associated.

35. The device of claim 27, wherein the device is a radio base station.

36. A method of handling neighbor relations of a first cell in a wireless communication network, the method comprising a device for handling neighbor relations:
selecting, based on the altitude of a wireless device being served by the first cell, a set of neighbor relations for the first cell from a number of sets of neighbor relations, where each set is associated with a different altitude interval; and
determining neighbor cells for the wireless device based on the selected set of neighbor relations.

37. The method of claim 36, further comprising:
obtaining an indication of the altitude of the wireless device;
performing the selecting based on the indication; and
informing the wireless device of the selected set of neighbor relations.

38. The method of claim 37, further comprising informing the wireless device of the content of the selected set of neighbor relations when informing the wireless device of the selection.

39. The method of claim 36, further comprising informing the wireless device of the content of all the sets of neighbor relations.

40. A wireless device for communication with a first cell of a wireless communication network, the wireless device comprising:
processing circuitry;
memory containing instructions executable by the processing circuitry whereby the wireless device is operative to:
obtain a number of sets of neighbor relations for the first cell, where each set is associated with a different altitude interval;
select, based on the altitude of the wireless device, a set of neighbor relations for the first cell from the number of sets of neighbor relations; and
determine neighbor cells for the wireless device, when the wireless device is being served by the first cell, based on the selected set of neighbor relations.

41. The wireless device of claim 40, wherein the instructions are such that the wireless device is operative to perform cell reselection based on the determined neighbor cells.

42. The wireless device of claim 40, wherein the instructions are such that the wireless device is operative to make link quality determinations based on the determined neighbor cells.

43. The wireless device of claim 40, wherein the instructions are such that the wireless device is operative to obtain an indication of the altitude of the wireless device.

44. A method of assisting in the handling of neighbor relations for a first cell in a wireless communication network, the method comprising a wireless device:
obtaining a number of sets of neighbor relations for the first cell, where each set is associated with a different altitude interval;
selecting, based on the altitude of the wireless device, a set of neighbor relations for the first cell from the number of sets of neighbor relations; and
determining neighbor cells for the wireless device, when the wireless device is being served by the first cell, based on the selected set of neighbor relations.

45. The method of claim 44, further comprising performing cell reselection based on the determined neighbor cells.

46. The method of claim 44, further comprising obtaining an indication of the altitude of the wireless device.
